(19) United States
(12) Patent Application Publication
(10) Pub. No.: US 2019/0105227 A1
(43) Pub. Date: Apr. 11, 2019

(54) SAUNA SYSTEM

(71) Applicant: DOYLE MCNEIL, RIVERVIEW, FL (US)

(72) Inventor: DOYLE MCNEIL, RIVERVIEW, FL (US)

(21) Appl. No.: 16/158,229

(22) Filed: Oct. 11, 2018

Related U.S. Application Data
(60) Provisional application No. 62/571,092, filed on Oct. 11, 2017.

(51) Int. Cl. A61H 33/06

(52) U.S. Cl. CPC A61H 33/065; A61H 2201/0207; A61H 2033/061; A61H 33/066

(57) ABSTRACT

The sauna system includes a sauna booth forming an enclosure. The sauna booth includes an electric sauna stove configured to heat to a plurality of sauna stones. The electric sauna stove is further configured to heat the enclosure of the sauna booth via the plurality of sauna stones. The sauna system may include a liquid vaporizer system that may include a liquid-reservoir configured to store a liquid, a heating-element configured to vaporize the liquid, and a delivery-system hydraulically coupled to the liquid-reservoir and configured to transport the liquid from the reservoir to the heating-element. The vaporizer system may further include a diffuser configured to receive a vapor from the heating-element and disburse the vapor into the enclosure of the sauna booth. The sauna system may be useful for providing heat and essential oil therapy.

### CROSS REFERENCE TO RELATED APPLICATION

The present application is related to and claims priority to U.S. Provisional Patent Application No. 62/571,092 filed 2017 Oct. 11, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of saunas and more specifically relates to a sauna system.

### 2. DESCRIPTION OF RELATED ART

Saunas are used in many cultures around the world including the United States as an apparatus for delivering dry heat and steam therapies. Dry heat and steam therapies are known for being a relaxing method of receiving numerous medicinal benefits. Every culture has their own unique rendition of a sauna; however, saunas are unanimously known for promoting relaxation and general wellbeing for users. Regular use of saunas can decrease hypertension, high blood pressure, along with many medically proven and anecdotal benefits.

Presently, existing conventional sauna art provides two general heat therapy methods. The first method of heat therapy is a steam room. The steam room is generally an enclosed space having high-temperature steam that creates a high-humidity environment. The second commonly known heat therapy method is a dry sauna, providing a very high-temperature low-humidity environment. Another common practice for a sauna user is to add essential oils to the environment. The essential oils may provide additional health benefits, both medically proven and anecdotal. Existing sauna infrastructures do not accommodate the usage of essential oils and extracts without cost prohibitive modification.

U.S. Pat. No. 6,157,005 to Shun-Tsung Lu relates to a dry-heat sauna machine. The described dry-heat sauna machine includes a frame having a vertical portion and a horizontal portion. A cloth cover covers the fame to form a sauna enclosure. An air-circulating device is attached to the horizontal portion of the frame. A programmer is attached to the sidewall of the frame. The air-circulating device includes a compressor attached to the horizontal portion of the frame and a partition covering the compressor to define a control chamber between the seat and the partition. A condenser, a heating element and a fan are all attached to said partition and received in the control chamber. The hot air is blown from the heating element into the sauna enclosure via the duct and through the louvers by the fan. The hot air combines with the sweat and becomes humid, and the water vapor in the hot air is recovered by the condenser. The condenser condenses the vapor in the hot, humid air and makes the air cool and dry. Then the cool, dry air is blown to the heating element again and continues to cycle in the sauna enclosure. The water that is condensed by the condenser flows to the tray via the tube.

### BRIEF SUMMARY OF THE INVENTION

In view of the foregoing disadvantages inherent in the known sauna art, the present disclosure provides a novel sauna system. The general purpose of the present disclosure, which will be described subsequently in greater detail, is to provide a novel sauna including a vaporizer.

A sauna system is disclosed herein. The sauna system includes a sauna booth forming an enclosure. The sauna booth includes an electric sauna stove configured to heat sauna stones. The electric sauna stove is further configured to heat the enclosure of the sauna booth via the sauna stones. The sauna system may include a liquid vaporizer system. The liquid vaporizer system may include liquid-reservoir configured to store a liquid. The vaporizer system further may include a heating-element configured to heat the liquid and convert the liquid into a vapor. A delivery-system may be hydraulically coupled to the liquid-reservoir and configured to transport the liquid from the reservoir to the heating-element. The vaporizer system may further include a diffuser configured to receive the vapor from the heating-element and disburse the vapor into the enclosure of the sauna booth.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a sauna system, constructed and operative according to the teachings of the present disclosure.

FIG. 1 is a front perspective view of the system during an ‘in-use’ condition, according to an embodiment of the disclosure.

FIG. 2 is a front perspective view of the system of FIG. 1, according to an embodiment of the present disclosure.

FIG. 3 is a flow chart of the system of FIG. 1, according to an embodiment of the present disclosure.

FIG. 4 is a front perspective view of the system of FIG. 1, according to an embodiment of the present disclosure.

FIG. 5 is a front perspective view of the system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a sauna means and more particularly to a sauna system as used to improve the use of saunas.

Generally, the sauna system may provide a therapeutic environment, where users are able to incorporate essential oils. The present invention is a full featured sauna system that includes a sauna stove configured to heat virtually any variety of sauna stones. The sauna system features a unitary essential oil vaporizer system designed to deliver vaporized oils to the sauna enclosure. The vaporizer system may embody various shapes, sizes, and designs. The vaporizer system may include a refillable reservoir configured to store one or more essential oils for vaporization. The vaporizer system includes adjustable heat settings, which allows for fine tuning the heat for the specific vaporization temperature of the oil used. In a preferred embodiment, the vaporizer system is configured to heat and vaporize legal cannabis oils. The cannabis oil may be mixed with natural solvents and other essential oils and extracts at the preference of the user.

Briefly stated, the sauna system provides a combination of three therapeutic functions. The first therapeutic function is a sauna therapy. In a preferred embodiment, the system includes an enclosed space having a heater device that may a dry, and alternatively, a wet heated environment. The second therapeutic function is a visual aesthetics therapy. The enclosed environment includes aesthetically pleasing artwork. The artwork may include murals of geographic scenes, projected pictures, videos, and any visual imagery that may be useful for therapeutic purposes. The third therapeutic function is aroma therapy. The system includes a vaporization unit configured to vaporize essential oils. The vaporization unit may saturate the enclosed area with an aerosol of the user's choosing. The aerosol may be used for both inhalation and topical treatment purposes.

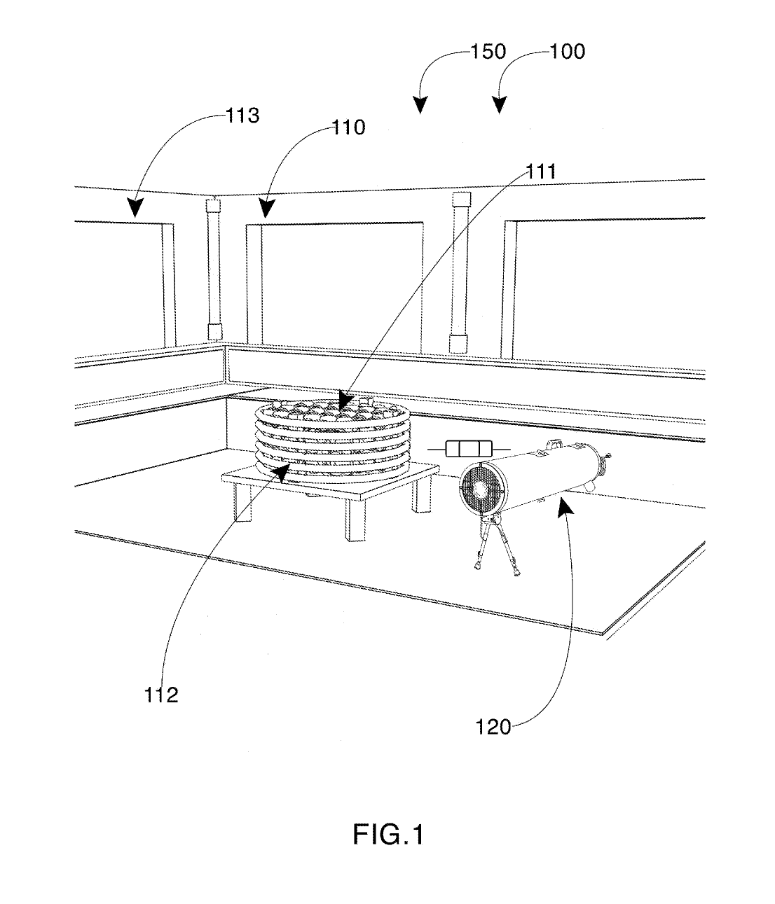

Referring now more specifically to the drawings by numerals of reference, there is shown in FIGS. 1-5, various views of a system 100. FIG. 1 shows a system 100 during an ‘in-use’ condition 150, according to an embodiment of the present disclosure. As illustrated, the system 100 may include a sauna booth 110 forming an enclosure 113; the sauna booth 110 may include a ceiling, a floor, and at least one vertical wall extending between the ceiling and the floor. Within the enclosure 113 of the sauna booth 110 may be an electric sauna stove 112 configured to heat to a plurality of sauna stones 111. The sauna stove 112 may be configured to heat the enclosure 113 of the sauna booth 110 via the plurality of sauna stones 111.

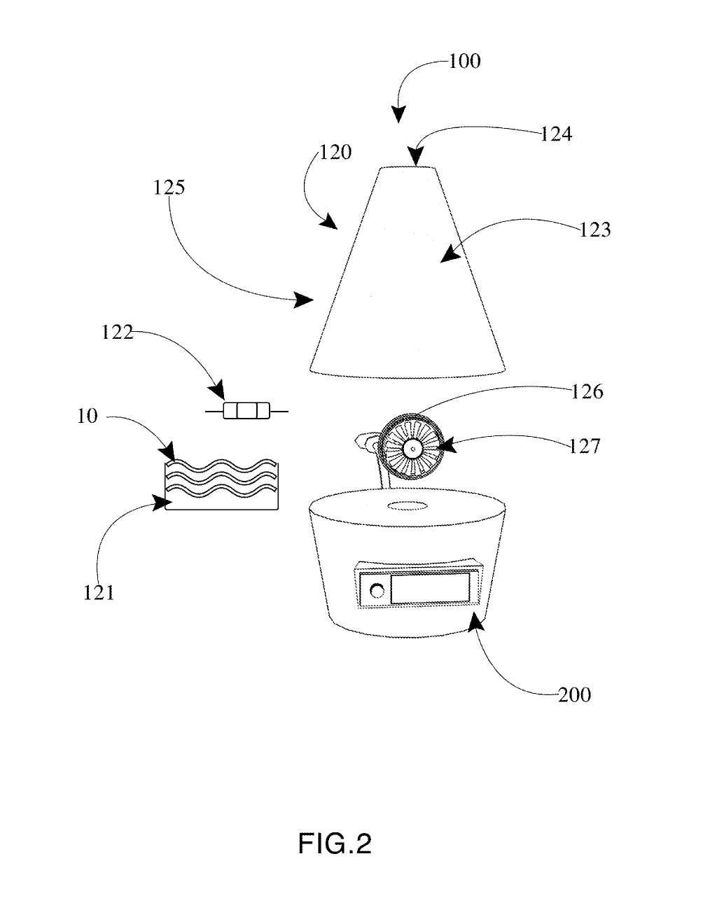

The sauna system 100 further may include a vaporizer system 120. The present figure illustrates a tubular shaped embodiment of the vaporizer system 120. However, the vaporizer system 120 may embody any conceived shape. The vaporizer system 120 may comprise a liquid-reservoir 121 (FIG. 2) configured to store a liquid 10 (FIG. 2) to be vaporized by a heating-element 122 (FIG. 2) or other suitable means. A delivery-system 123 (FIG. 2) may be hydraulically coupled to the liquid-reservoir 121 and configured to transport the liquid 10 from the liquid-reservoir to the heating-element 122. A diffuser 124 (FIG. 2) may be included and configured to receive a vapor from the heating-element 122 and disburse the vapor into the enclosure 113 of the sauna booth 110.

FIG. 2 shows a front perspective view of the system 100 of FIG. 1, according to an embodiment of the present disclosure. As above, the system 100 may include a vaporizer system 120. In this embodiment, the vaporizer system 120 is shown as being conically shaped. Sizes and dimensions of the vaporizer system 120 may change while retaining the functional capability of vaporizing a liquid 10. The vaporizer system 120 may include a liquid-reservoir 121 configured to store a liquid 10. The liquid-reservoir 121 may be refillable and may embody any form capable of storing a liquid 10.

A heating-element 122 is configured to vaporize the liquid 10. The heating-element 122 may embody a resistance heater powered by electricity. The heating-element 122 may comprise a nichrome wire, alternatively, another conductive material. The heating-element 122 may be configured to generate heat.

A delivery-system 123 may be hydraulically coupled to the liquid-reservoir 121 and configured to transport the liquid 10 from the liquid-reservoir 121 to the heating-element 122. The delivery-system 123 may embody a pump and a conduit having the function to displace the liquid 10 from the liquid-reservoir 121. The delivery-system 123 may be controlled and monitored for throughput and efficiency. The vaporizer system 120 may further include a housing 125 configured to retain the liquid-reservoir 121, the heating-element 122, and the delivery-system 123.

At least one diffuser 124 may be configured to receive a vapor from the heating-element 122 and disburse the vapor into the enclosure 113 (FIG. 1) of the sauna booth 110 (FIG. 1). The diffuser 124 may include a screen and other alternative means of equally distributing the vapor. The diffuser 124 may have adjustable settings allowing for modulating the throughput of the vapor. The vaporizer system 120 may further include a motor 126 configured to rotate a fan 127. The motor 126 may be configured to convert electrical power into mechanical rotation. The fan 127 may be configured to draw the vapor through the delivery-system 123. The fan 127 may include an impeller configured to move a fluid by rotation. The vaporizer system 120 may include a user-interface 200. The user-interface 200 may be configured to display information pertaining to the operation of the vaporizer system 120.

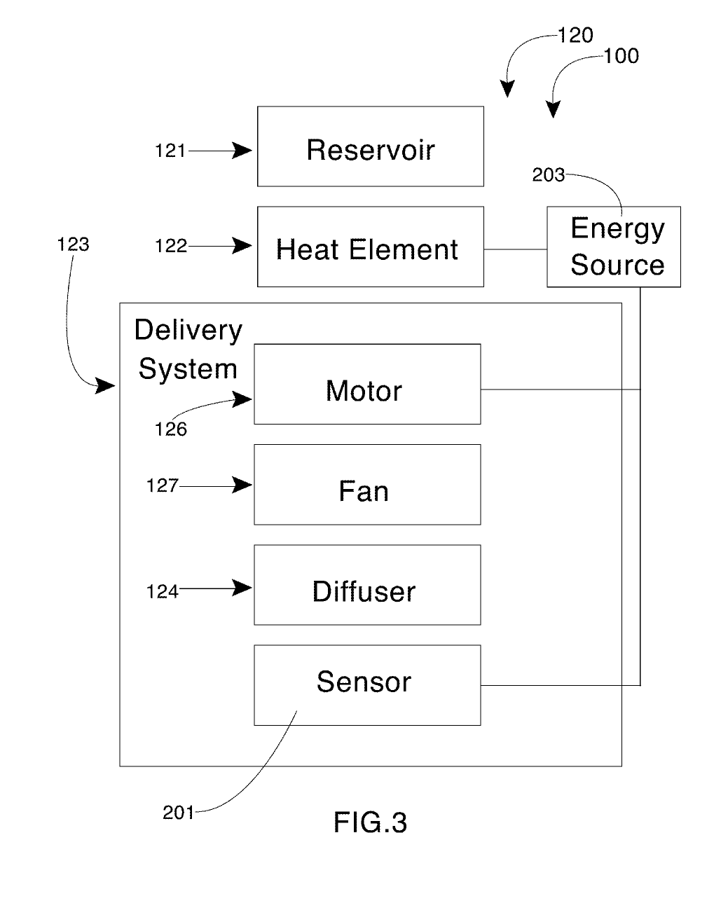

Referring now to FIG. 3 showing a flow diagram of the system 100 of FIG. 1, according to an embodiment of the present disclosure. As above, the system 100 may include a vaporizer system 120. The vaporizer system comprises a liquid-reservoir 121 configured to store a liquid 10 (FIG. 1) to be vaporized by a heating-element 122. A delivery-system 123 may be hydraulically coupled to the liquid-reservoir 121 and configured to transport the liquid 10 from the liquid-reservoir 121 to the heating-element 122. The vaporizer system 120 may further include a motor 126 configured to rotate a fan 127. The vaporizer system 120 may include a sensor-circuit 201 configured to measure output of the vapor through the delivery-system 123. The sensor-circuit may comprise any suitable means for measuring output of vapor through the delivery-system 123. The sensor-circuit 201 may comprise spectroscopic, laser, pressure, and further conceived means of measuring output of vapor. The sensor-circuit 201 may also be configured to measure the output of vapor through the diffuser 124 The vaporizer system 120 may further include an energy-supply 203 configured to provide power to the motor 126, the sensor-circuit 201, and the heating-element 122.

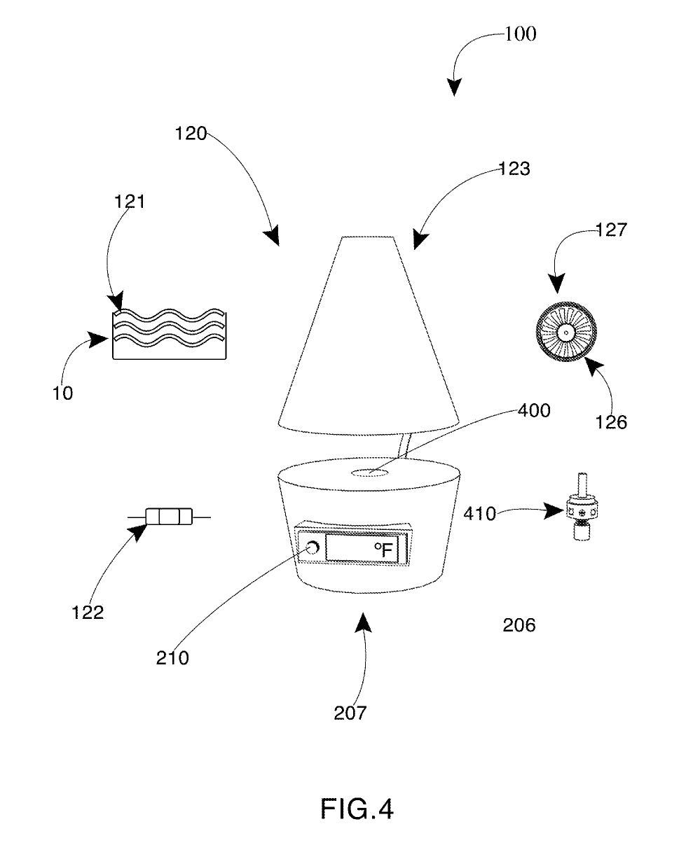

FIG. 4 shows a front perspective view of the system 100 of FIG. 1, according to an embodiment of the present disclosure. As above, the system 100 may include a vaporizer system 120. The vaporizer system 120 comprises a liquid-reservoir 121 configured to store a liquid 10 to be vaporized by a heating-element 122. A delivery-system 123 may be hydraulically coupled to the liquid-reservoir 121 and configured to transport the liquid 10 from the liquid-reservoir 121 to the heating-element 122. The vaporizer system 120 may further include a motor 126 configured to rotate a fan 127. The vaporizer system 120 may further include a switch 210 in electrical communication with the sensor-circuit 201 (FIG. 3). The switch 210 configured to actuate the motor 126 and the heating-element 122.

The vaporizer system 120 may further include a threaded aperture 400 configured to receive prefabricated atomizer coils 410. The threading of the threaded aperture may include all suitable threading standards in alternate embodiments. The vaporizer system 120 includes a temperature-controller 207. The temperature-controller 207 may be configured to disable the heating-element 122 at a threshold temperature. The temperature-controller 207 may further be configured to adjust the temperature of the heating-element 122.

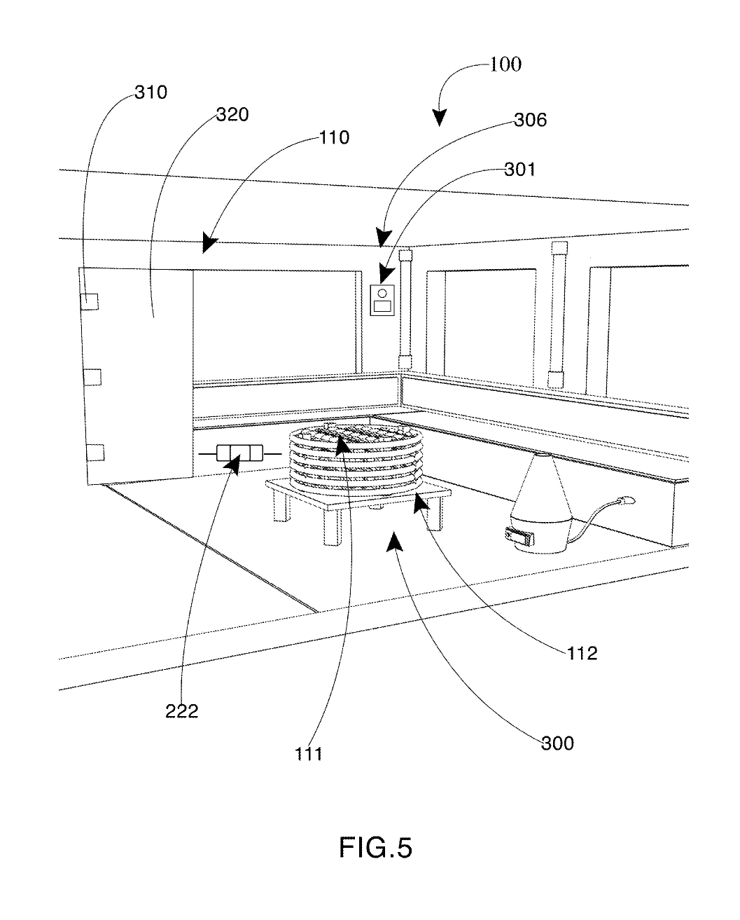

Referring now to FIG. 5 showing a front perspective view of the system 100 of FIG. 1, according to an embodiment of the present disclosure. As above, the system 100 may include the electric sauna stove 112 further including a sauna-stove-heating-element 222 configured to heat the plurality of sauna stones 111. The electric sauna stove 112 includes a timer 300 configured to deactivate the electric sauna stove 112 after a predetermined time-period. The electric sauna stove 112 includes a sauna-temperature-controller 301. The sauna-temperature-controller 301 may be configured to adjust the temperature of the sauna-stove-heating-element 222. The sauna booth 110 further includes a temperature gauge 306 disposed in the enclosure 113 (FIG. 1). The temperature gauge 306 may be configured to display the temperature of the heating-element 122.

In one embodiment, the sauna booth 110 may further include a door 320 having a plurality of magnets 310 configured to retain the door 320 in a closed position. The door 320 may be pivotably connected to the sauna booth 110. The plurality of magnets 310 may be configured to easily push the door 320 open. The plurality of magnets 310 further allowing the door 320 to create a fluid proof seal when the door 320 is in a closed state.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A sauna system comprising:
a sauna booth forming an enclosure, the sauna booth including a ceiling, a floor, and at least one vertical wall extending between the ceiling and the floor;
an electric sauna stove configured to heat to a plurality of sauna stones, and to heat the enclosure of the sauna booth via the plurality of sauna stones; and
a liquid vaporizer system including
a liquid-reservoir configured to store a liquid,
a heating-element configured to vaporize the liquid,
a delivery-system hydraulically coupled to the liquid-reservoir and configured to transport the liquid from the reservoir to the heating-element, and
a diffuser configured to receive a vapor from the heating-element and disburse the vapor into the enclosure of the sauna booth.

2. The sauna system of claim 1, wherein the liquid vaporizer system further includes a housing configured to retain the liquid-reservoir, the heating-element, and the delivery-system.

3. The sauna system of claim 1, wherein the liquid vaporizer system further includes a motor configured to rotate a fan.

4. The sauna system of claim 3, wherein the fan is configured to draw the vapor through the delivery-system.

5. The sauna system of claim 1, wherein the liquid vaporizer system further includes a sensor-circuit configured to measure output of the vapor through the delivery-system.

6. The sauna system of claim 5, wherein the liquid vaporizer system further includes an energy-supply configured to provide power to the motor, the sensor-circuit, and the heating-element.

7. The sauna system of claim 6, wherein the liquid vaporizer system further includes a switch in electrical communication with the sensor-circuit, the switch configured to actuate the motor and the heating-element.

8. The sauna system of claim 1, wherein the heating-element includes a nichrome wire, and alternatively, another conductive material.

9. The sauna system of claim 1, wherein the electric sauna stove further includes a sauna-stove-heating-element configured to heat the plurality of sauna stones.

10. The sauna system of claim 1, wherein the electric sauna stove includes a timer configured to deactivate the electric sauna stove after a predetermined time-period.

11. The sauna system of claim 1, wherein the sauna booth further includes a door having a plurality of magnets configured to retain the door in a closed position.

12. The sauna system of claim 1, wherein the sauna booth further includes a temperature gauge disposed in the enclosure.

13. The sauna system of claim 1, wherein the liquid vaporizer system further includes a threaded aperture configured to receive prefabricated atomizer coils.

14. The sauna system of claim 1, wherein the electric sauna stove includes a temperature-controller.

15. The sauna system of claim 14, wherein the liquid vaporizer system includes a temperature-controller.

16. The sauna system of claim 1, wherein the liquid vaporizer system includes a user-interface.

17. A sauna system comprising:
a sauna booth forming an enclosure, the sauna booth including a ceiling, a floor, and at least one vertical wall extending between the ceiling and the floor,
an electric sauna stove configured to heat to a plurality of sauna stones, and to heat the enclosure of the sauna booth via the plurality of sauna stones, and
a liquid vaporizer system including:
a liquid-reservoir configured to store a liquid,
a heating-element configured to vaporize the liquid,
a delivery-system hydraulically coupled to the liquid-reservoir and configured to transport the liquid from the reservoir to the heating-element, and
a diffuser configured to receive a vapor from the heating-element and disburse the vapor into the enclosure of the sauna booth; and
wherein the liquid vaporizer system further includes a housing configured to retain the liquid-reservoir, the heating-element, and the delivery-system;
wherein the liquid vaporizer system further includes a motor configured to rotate a fan;
wherein the fan is configured to draw the vapor through the delivery-system;
wherein the liquid vaporizer system further includes a sensor circuit configured to measure output of the vapor through the delivery-system;
wherein the liquid vaporizer system further includes an energy-supply configured to provide power to the motor, the sensor-circuit, and the heating-element;
wherein the liquid vaporizer system further includes a switch in electrical communication with the sensor-circuit, the switch configured to actuate the motor and the heating-element;
wherein the heating-element includes a nichrome wire, and alternatively, another conductive material;
wherein the electric sauna stove further includes a sauna-stove-heating-element configured to heat the plurality of sauna stones;
wherein the electric sauna stove includes a timer configured to deactivate the electric sauna stove after a predetermined time-period;
wherein the sauna booth further includes a door having a plurality of magnets configured to retain the door in a closed position;
wherein the sauna booth further includes a temperature gauge disposed in the enclosure;
wherein the liquid vaporizer system further includes a threaded aperture configured to receive prefabricated atomizer coils;
wherein the electric sauna stove includes a temperature-controller;
wherein the liquid vaporizer system includes a temperature-controller;
wherein the liquid vaporizer system includes a user-interface;
